(19) United States
(12) Patent Application Publication
(10) Pub. No.: US 2025/0373726 A1
(43) Pub. Date: Dec. 4, 2025

(54) METHODS AND APPARATUS TO FACILITATE RETURNS VIA AUDIO CALLS

(71) Applicant: Returned.com, Inc., Boulder, CO (US)

(72) Inventors: Patrick A. Justis, Longmont, CO (US); Paul Pao-Yen Lin, Boulder, CO (US)

(21) Appl. No.: 18/903,707

(22) Filed: Oct. 1, 2024

Related U.S. Application Data
(60) Provisional application No. 63/652,491, filed on May 28, 2024.

(51) Int. Cl. H04M 3/493; H04M 3/22

(52) U.S. Cl. CPC H04M 3/493; H04M 3/2218; H04M 2203/1058

(57) ABSTRACT

Methods and apparatus to facilitate returns via audio calls are disclosed. Example machine-readable instructions cause at least one processor circuit to at least determine metadata associated with a return, generate phrases corresponding to the metadata, compare the generated phrases to stored phrases in an audio cache, when a first stored phrase of the stored phrases matches a first generated phrase of the generated phrases, access a first stored audio file of the stored audio files, the first stored audio file associated with the matching first stored phrase, generate an audio file for a second generated phrase of the generated phrases, the second generated phrase different from the stored phrases, store the generated audio file in the audio cache in association with the second generated phrase, and execute an audio call with the stored phrases, the audio call directed to a retailer to attempt to coordinate the return.

### RELATED APPLICATION

This patent claims the benefit of U.S. Provisional Patent Application No. 63/652,491, which was filed on May 28, 2024. U.S. Provisional Patent Application No. 63/652,491 is hereby incorporated by reference in its entirety. Priority to U.S. Provisional Patent Application No. 63/652,491 is hereby claimed.

### FIELD OF THE DISCLOSURE

This disclosure relates generally to consumer advocacy and, more particularly, to methods and apparatus to facilitate returns via audio calls.

### BACKGROUND

In recent years, increases in commercialism and digital advertising have led to a rise in consumer purchasing. In many examples, a consumer may purchase a product, only to later return the product. A consumer may return a product for any reason, including but not limited to, the product arriving as damaged, the product not matching a corresponding description, the consumer finding an alternative product with lower cost and/or better performance, and/or more generally, the consumer no longer wanting or needing the originally purchased product.

### BRIEF DESCRIPTION OF THE DRAWINGS

FIG. 1 is a block diagram of an example environment in which an example return coordinator server operates to facilitate a return between an example consumer and an example retailer.

FIG. 2 is a block diagram of an example implementation of the example return coordinator server of FIG. 1.

FIG. 3 is an example process flow diagram showing an example implementation of the example return coordinator server of FIG. 1.

FIGS. 4-7 are flowcharts representative of example machine readable instructions and/or example operations that may be executed, instantiated, and/or performed by example programmable circuitry to implement the return coordinator server of FIG. 2.

FIG. 8 is a block diagram of an example processing platform including programmable circuitry structured to execute, instantiate, and/or perform the example machine readable instructions and/or perform the example operations of FIGS. 4-7 to implement the return coordinator server of FIG. 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 4-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Consumers can purchase goods and/or services through many different retailers and/or entities. Such consumers may, in some examples, seek to return and/or cancel such goods and/or services. Different retailers and/or entities may utilize different platforms that enable a consumer to request a refund and/or return of a purchased good or service. Some entities implement policies by which a consumer may interact with the entity. Such interactions may support various actions conducted between the consumer and the entity such as, for example, returning a purchased item, negotiating a new price for a service, etc. Some entities may invest in infrastructure that enables such interactions to be conducted in an efficient manner for a consumer. For example, some retailers enable a consumer to fill out a return form on their website by clicking a link and requesting the return of an item.

However, not all entities are as user-friendly. Some entities might implement text-based (e.g., a chat session, an email address, etc.) and/or voice-based (e.g., a telephonic voice session) customer service department(s) with which the consumer may interact. As used herein, the terms “agent,” “retail agent,” “customer service agent,” or “retail representative” are used interchangeably to refer to a human agent or a robot (e.g., an artificial intelligence (AI) chat bot) configured to answer calls, facilitate returns, talk with consumers, participate in chat sessions, etc., via text-based or voice-based technologies on behalf of an example retailer. In such instances, interacting with such text-based and/or voice-based customer service agents might be overly time-consuming for consumers. Moreover, because different entities might use different customer service systems, consumers are faced with understanding the various systems for interacting with the different entities.

Examples disclosed herein enable the return of products in a manner that reduces complexity for any person involved in the return of a product. Examples disclosed herein initiate and conduct audio calls with an agent (e.g., robotic representative, human representative, etc.) of a retailer to facilitate returns. Disclosed examples can provide return data (e.g., order number, order receipt, consumer identity information, etc.) to the example representative on behalf of a consumer. For example, disclosed examples provide access to and/or continuously update an example audio cache storing common phrases, anticipated phrases, and/or expected phrases involved in a return between an example consumer and an example retailer. As such, disclosed examples minimize or eliminate direct consumer involvement with a retail representative.

Although the examples disclosed herein are related to product returns, the same and/or similar process(es) can equally be used to automate other consumer activities. Examples of other activities this process can accommodate include refunds, exchanges, order cancellations, warranty claims, service repairs, product recalls, order status questions, billing issues, shipping and delivery issues, product inquiries, gift card and voucher inquiries, account upgrades and downgrades, product specification questions, price adjustments, etc.

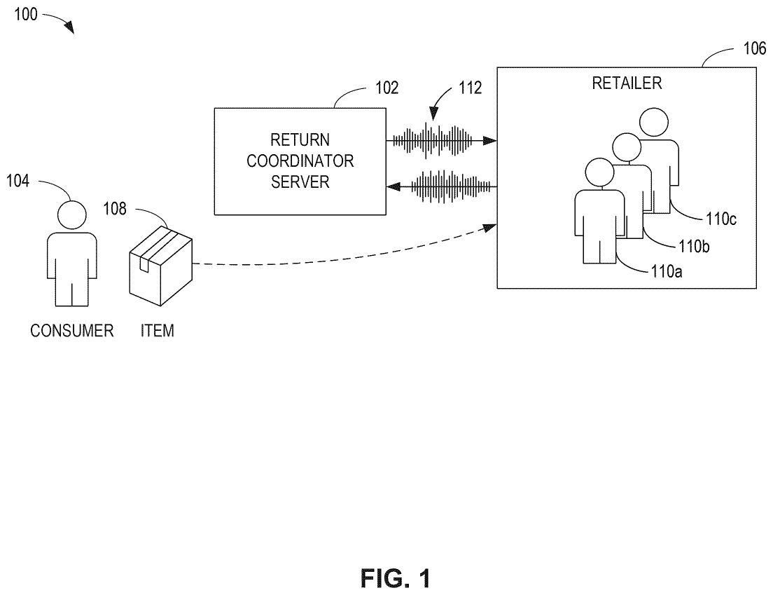

FIG. 1 is a block diagram of an example environment 100 in which an example return coordinator server 102 operates to facilitate a return between an example consumer 104 and an example retailer 106. In the example of FIG. 1, the consumer 104 had previously purchased an example item 108 from the retailer 106 and requests a return of the item 108. The example item 108 can be clothing, housewares, furniture, office supplies, groceries, cosmetic products, medical supplies, and/or any item that can be purchased from an example retailer (e.g., an online retailer). The example retailer 106 includes example agents 110a-110c that interact, engage, and/or otherwise converse with the return coordinator server 102. For example, an example transmission 112 (e.g., call) between the return coordinator server 102 and the retailer 106 can carry audio files, text files, etc., to aid in the facilitation of the return. In some examples, the transmission 112 can relay identification information associated with the consumer 104 (e.g., name, address, payment information, demographic data, etc.), identification information associated with the item 108 (e.g., price, type, barcode number, color, date purchased, etc.), identification information associated with the retailer 106 (e.g., address, return policies, store number, etc.). Typically, the example consumer 104 initiates the return by placing an audio call to the retailer 106. However, the return associated with FIG. 1 can be initiated via email, chat box, text message, an online form on a website associated with the retailer 106, etc.

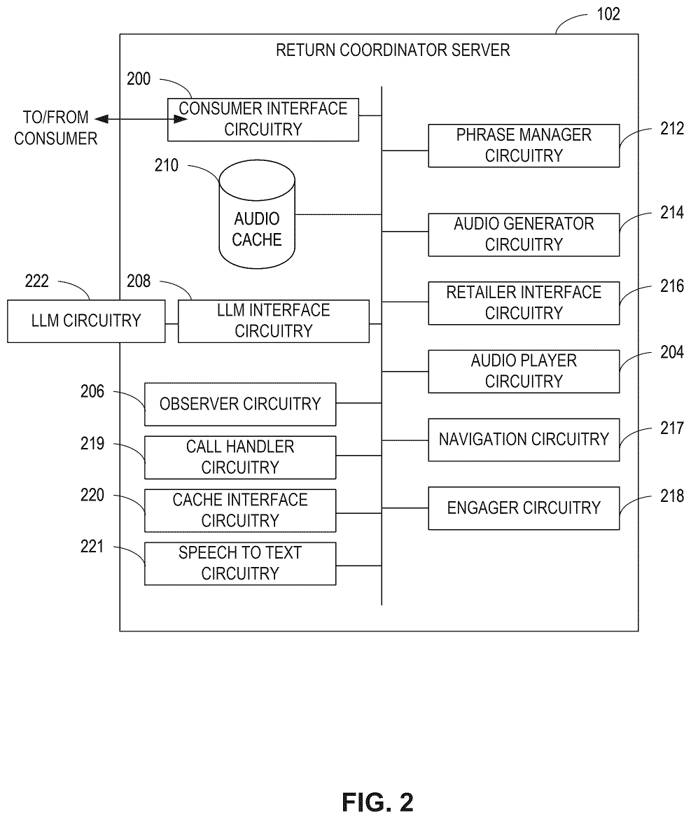

FIG. 2 is a block diagram of an example implementation of the return coordinator server 102 of FIG. 1 to facilitate the return of the item 108. The example return coordinator server 102 includes example consumer interface circuitry 200, example audio player circuitry 204, example observer circuitry 206, example Large Language Model (LLM) interface circuitry 208, an example audio cache 210, example phrase manager circuitry 212, example audio generator circuitry 214, example retailer interface circuitry 216, example navigation circuitry 217, example engager circuitry 218, example call handler circuitry 219, example cache interface circuitry 220, and example speech to text circuitry 221.

The return coordinator server 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the return coordinator server 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example consumer interface circuitry 200 accesses instructions to coordinate a return on behalf of the consumer 104. For example, the consumer interface circuitry 200 may be communicatively coupled to a consumer device associated with the consumer 104 to access the instructions. Further, the example consumer interface circuitry 200 identifies details of the return. For example, the consumer interface circuitry 200 identifies the item 108, the consumer 104, any information associated with the item 108 (e.g., type, price, color, barcode number, etc.), any information associated with the consumer 104 (e.g., address, payment information, username, etc.).

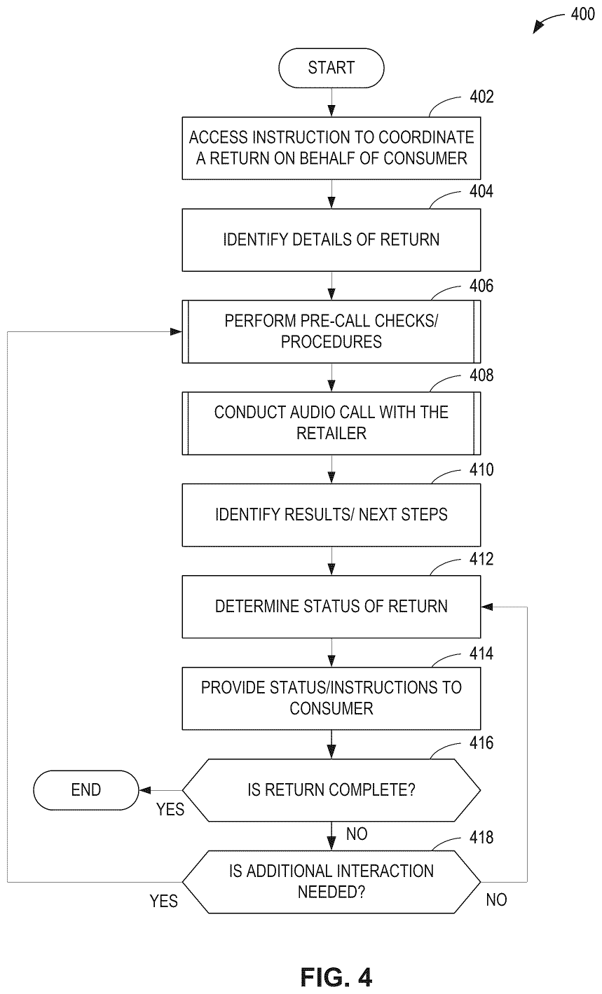

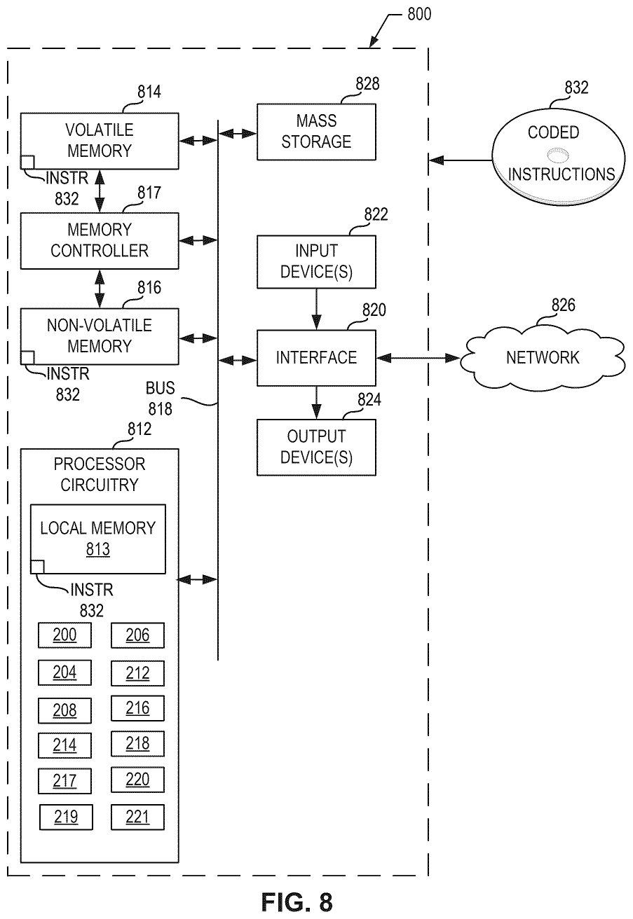

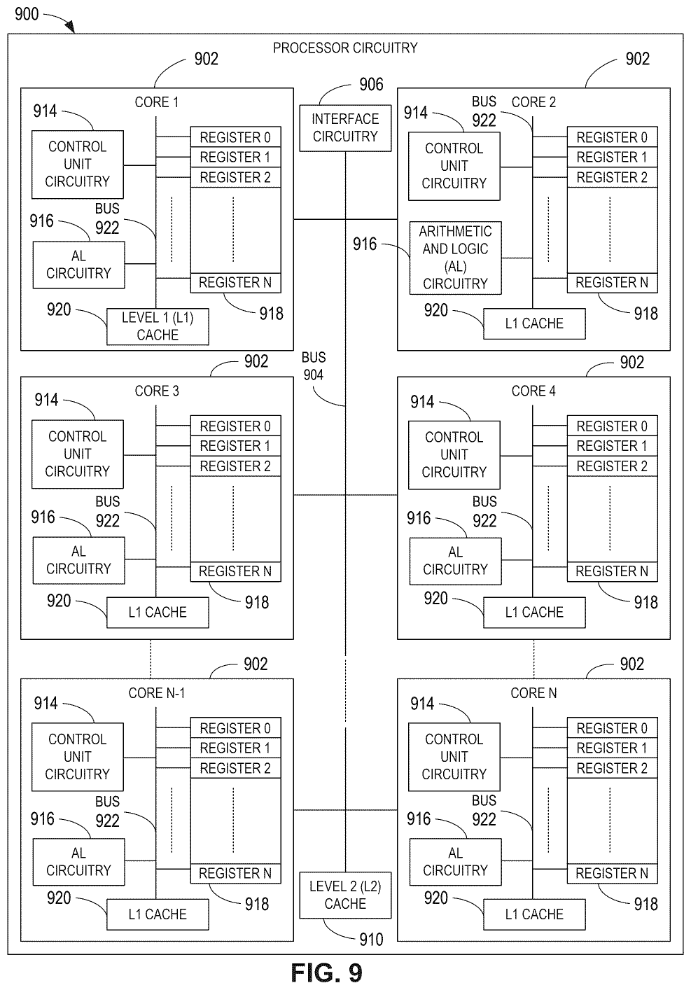

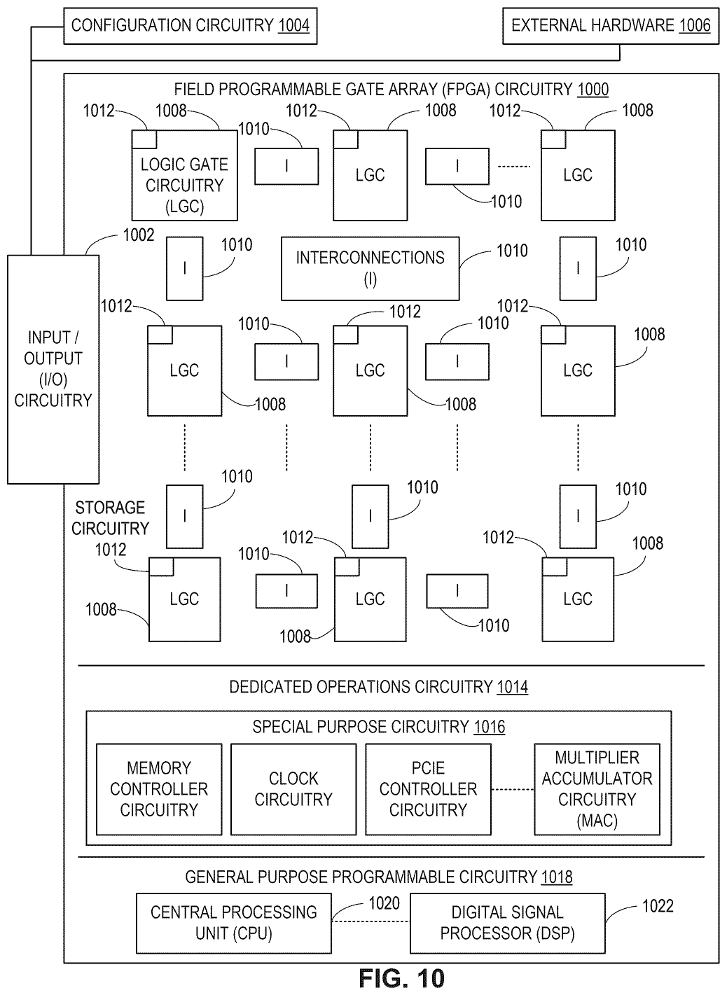

In some examples, the consumer interface circuitry 200 is instantiated by programmable circuitry executing consumer interfacing instructions and/or configured to perform operations such as those represented by the flowchart of FIG. 4. In some examples, the return coordinator server 102 includes first means for interfacing. For example, the first means for interfacing may be implemented by the consumer interface circuitry 200. In some examples, the consumer interface circuitry 200 may be instantiated by programmable circuitry such as the example programmable circuitry 812 of FIG. 8. For instance, example the consumer interface circuitry 200 may be instantiated by the example microprocessor 900 of FIG. 9 executing machine executable instructions such as those implemented by at least blocks 402, 404, 418 of FIG. 4. In some examples, the consumer interface circuitry 200 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the consumer interface circuitry 200 may be instantiated by any other combination of hardware, software, and/or firmware. For example, the consumer interface circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example audio cache 210 stores phrases (e.g., common phrases, anticipated phrases, etc.) that may be spoken, heard, and/or otherwise exchanged during an example call between the return coordinator server 102 and the retailer 106. In some examples, a list of common phrases (stored in the audio cache 210) may include sentences, questions, answers, etc., that the return coordinator server 102 has identified as frequently exchanged in example calls. For example, common phrases may include “Good morning,” “I need to return something,” “When can I expect a refund,” “Can you please repeat that,” etc. Additionally, a list of anticipated phrases (stored in the audio cache 210) may include sentences, questions, answers, etc., that the return coordinator server 102 has identified as frequently exchanged in example calls associated with the retailer 106, the consumer 104, the item 108, etc. In other words, an example list of anticipated phrases may include phrases that are situation specific, consumer specific, retailer specific, item specific, etc. For example, if the return coordinator server 102 has previously facilitated a return with the retailer 106, and the agents 110a-110c associated with the retailer 106 communicated that the retailer 106 offers store credit instead of refunds, then an anticipated phrase may be “How many days do I have to spend any store credit that I receive with this return?” Further, the example audio cache 210 includes audio data (e.g., voice data, files, recordings, etc.) associated with each of the phrases in the audio cache 210.

The example phrase manager circuitry 212 accesses the list of common phrases (e.g., “I need to return my item.”). Additionally, the example phrase manager circuitry 212 generates a list of anticipated phrases (e.g., based on the item 108, the retailer 106, the consumer 104, etc.). The example phrase manager circuitry 212 merges the list of common phrases and the list of anticipated phrases to form an example list of expected phrases. As such, the example phrase manager circuitry 212 can access, identify, and/or select any phrase in the list of expected phrases. The example phrase manager circuitry 212 determines whether the audio cache 210 has corresponding audio for any of the phrases in the list of expected phrases.

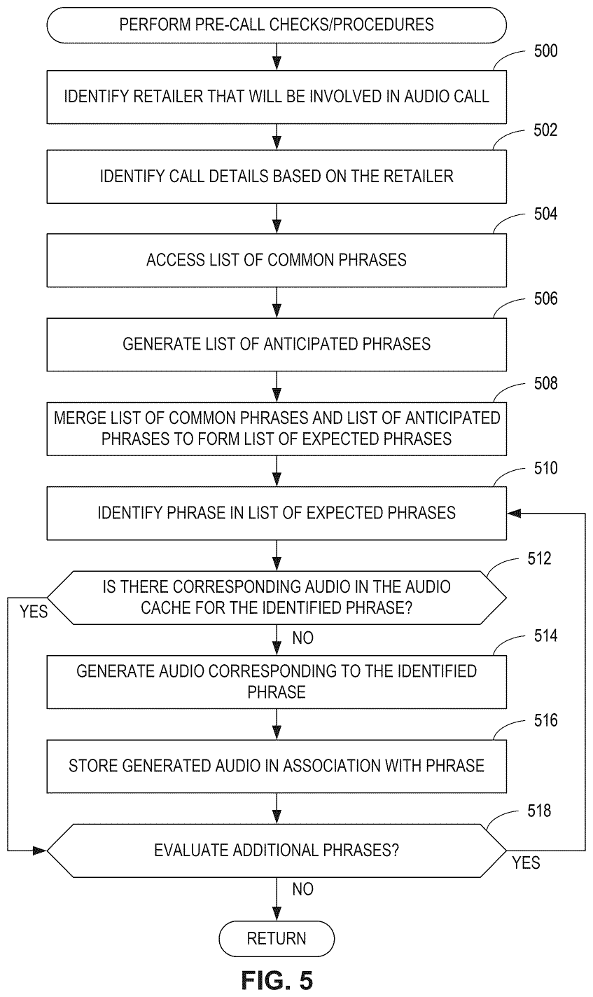

In some examples, the phrase manager circuitry 212 is instantiated by programmable circuitry executing phrase managing instructions and/or configured to perform operations such as those represented by the flowcharts of FIGS. 4 and 5. In some examples, the return coordinator server 102 includes means for managing phrases. For example, the means for managing phrases may be implemented by the example phrase manager circuitry 212. In some examples, the phrase manager circuitry 212 may be instantiated by programmable circuitry such as the example programmable circuitry 812 of FIG. 8. For instance, the example phrase manager circuitry 212 may be instantiated by the example microprocessor 900 of FIG. 9 executing machine executable instructions such as those implemented by at least block 406 of FIG. 4 and blocks 504, 506, 508, 510, 512, 518 of FIG. 5. In some examples, the phrase manager circuitry 212 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the phrase manager circuitry 212 may be instantiated by any other combination of hardware, software, and/or firmware. For example, the phrase manager circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example retailer interface circuitry 216 identifies the retailer 106 that will be involved in the audio call. For example, the retailer interface circuitry 216 identifies call details (e.g., an address, a store number, a type of agent (e.g., the agents 110a-110c), an industry) based on the retailer 106.

In some examples, the retailer interface circuitry 216 is instantiated by programmable circuitry executing retailer interfacing instructions and/or configured to perform operations such as those represented by the flowchart of FIG. 5. In some examples, the return coordinator server 102 includes second means for interfacing. For example, the second means for interfacing may be implemented by the example retailer interface circuitry 216. In some examples, the retailer interface circuitry 216 may be instantiated by programmable circuitry such as the example programmable circuitry 812 of FIG. 8. For instance, the example retailer interface circuitry 216 may be instantiated by the example microprocessor 900 of FIG. 9 executing machine executable instructions such as those implemented by at least blocks 500, 502 of FIG. 5. In some examples, the retailer interface circuitry 216 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the retailer interface circuitry 216 may be instantiated by any other combination of hardware, software, and/or firmware. For example, the retailer interface circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example audio generator circuitry 214 generates audio for an example phrase. For example, if the phrase manager circuitry 212 determines that the audio cache 210 does not have corresponding audio for an example phrase, then the example audio generator circuitry 214 generates audio corresponding to the example phrase. In turn, the example audio generator circuitry 214 stores the generated audio in the audio cache 210 in association with the example phrase. In some examples, the audio generator circuitry 214 generates audio corresponding to the selected phrase when the cache interface circuitry 220 determines that the selected phrase cannot be divided into sub-components.

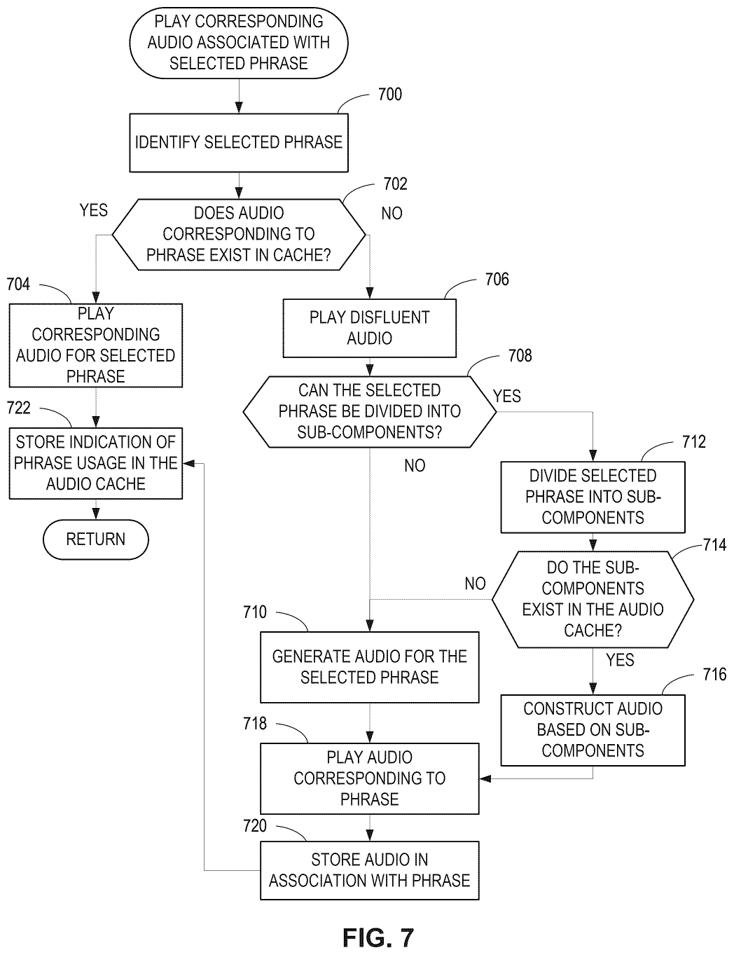

In some examples, the audio generator circuitry 214 is instantiated by programmable circuitry executing audio generation instructions and/or configured to perform operations such as those represented by the flowcharts of FIGS. 5 and 7. In some examples, the return coordinator server 102 includes means for generating audio. For example, the means for generating audio may be implemented by the example audio generator circuitry 214. In some examples, the audio generator circuitry 214 may be instantiated by programmable circuitry such as the example programmable circuitry 812 of FIG. 8. For instance, the example audio generator circuitry 214 may be instantiated by the example microprocessor 900 of FIG. 9 executing machine executable instructions such as those implemented by at least blocks 514, 516 of FIG. 5 and block 710 of FIG. 7. In some examples, the audio generator circuitry 214 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the audio generator circuitry 214 may be instantiated by any other combination of hardware, software, and/or firmware. For example, the audio generator circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example call handler circuitry 219 conducts an example audio call with the retailer 106. For example, the call handler circuitry 219 places (e.g., initiates, dials, etc.) the call to the retailer 106. The example call handler circuitry 219 collects audio from one of the agents 110a-110c. In some examples, the call handler circuitry 219 determines whether the recognition confidence associated with the agent audio meets a confidence threshold.

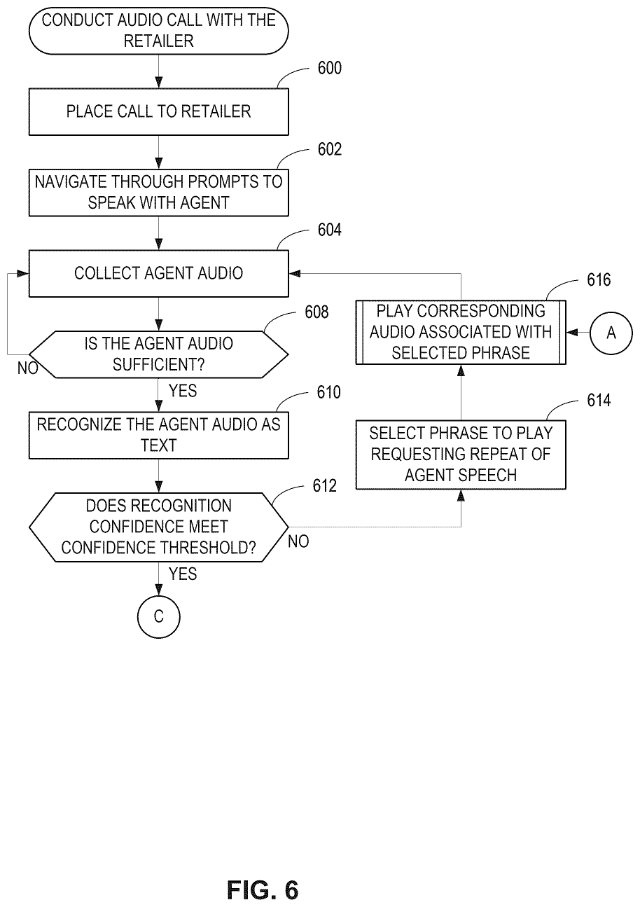

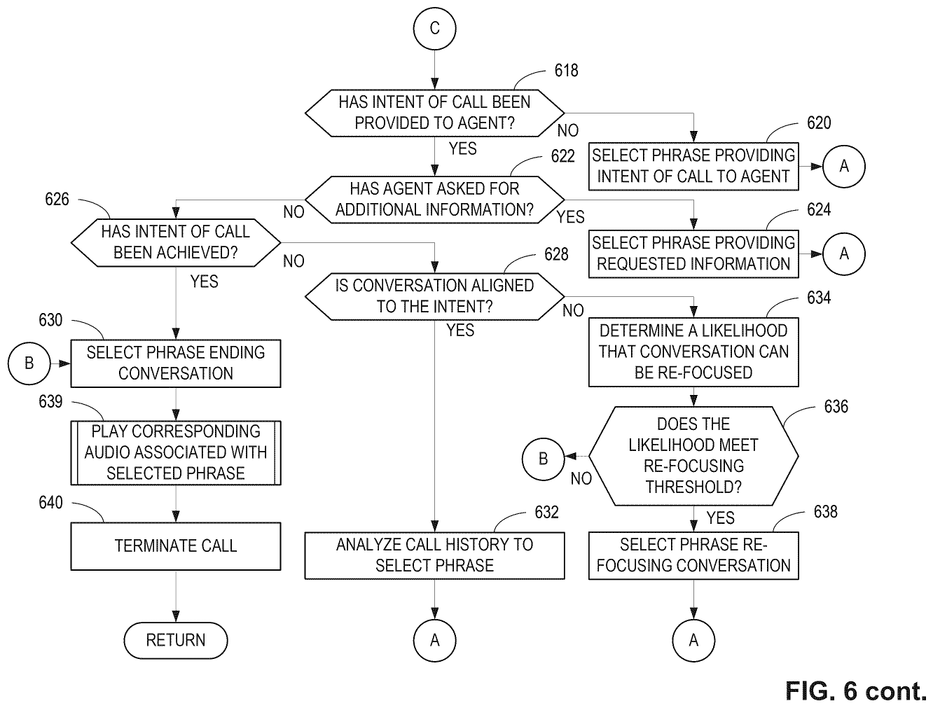

In some examples, the call handler circuitry 219 is instantiated by programmable circuitry executing call handling instructions and/or configured to perform operations such as those represented by the flowcharts of FIGS. 4 and 6. In some examples, the return coordinator server 102 includes means for handling. For example, the means for handling may be implemented by the example call handler circuitry 219. In some examples, the call handler circuitry 219 may be instantiated by programmable circuitry such as the example programmable circuitry 812 of FIG. 8. For instance, the example call handler circuitry 219 may be instantiated by the example microprocessor 900 of FIG. 9 executing machine executable instructions such as those implemented by at least block 408 of FIG. 4 and blocks 600, 604, 608, 612, 640 of FIG. 6. In some examples, the call handler circuitry 219 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the call handler circuitry 219 may be instantiated by any other combination of hardware, software, and/or firmware. For example, the call handler circuitry 219 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example speech to text circuitry 221 recognizes (e.g., converts) the agent audio as text. In some examples, the speech to text circuitry 221 uses machine learning models and/or other techniques to convert spoken speech into text for further processing. In some examples, the speech to text circuitry 221 interfaces with an external service (e.g., a third party service) to facilitate such conversion from speech to text. In some examples, the conversion from speech to text may additionally result in an indication of a confidence in the accuracy of the prediction. Such confidence may correspond to a recent time window (e.g., the last five seconds). In some examples, a low confidence value may result in additional delays until a subsequent conversion of the audio to text results in a higher confidence.

In some examples, the speech to text circuitry 221 is instantiated by programmable circuitry executing speech to text instructions and/or configured to perform operations such as those represented by the flowchart of FIG. 6. In some examples, the speech to text circuitry 221 is instantiated by programmable circuitry executing speech to text instructions and/or configured to perform operations such as those represented by the flowchart of FIG. 6. In some examples, the return coordinator server 102 includes means for converting. For example, the means for converting may be implemented by the example speech to text circuitry 221. In some examples, the speech to text circuitry 221 may be instantiated by programmable circuitry such as the example programmable circuitry 812 of FIG. 8. For instance, the speech to text circuitry 221 may be instantiated by the example microprocessor 900 of FIG. 9 executing machine executable instructions such as those implemented by at least block 610 of FIG. 6. In some examples, the speech to text circuitry 221 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the speech to text circuitry 221 may be instantiated by any other combination of hardware, software, and/or firmware. For example, the speech to text circuitry 221 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example navigation circuitry 217 navigates through prompts (e.g., “Press 1 to return an item,” “Press 2 to speak with an agent,” etc.) to speak with one of the agents 110a-110c. To do so, the example navigation circuitry 217 may cause the audio player circuitry 204 to emit dual-tone multi-frequency (DTMF) signals to indicate to the agent and/or a call processing system of the retailer what tone is being sent.

In some examples, the navigation circuitry 217 is instantiated by programmable circuitry executing navigation instructions and/or configured to perform operations such as those represented by the flowchart of FIG. 6. In some examples, the return coordinator server 102 includes means for navigating. For example, the means for navigating may be implemented by the example navigation circuitry 217. In some examples, the navigation circuitry 217 may be instantiated by programmable circuitry such as the example programmable circuitry 812 of FIG. 8. For instance, the example navigation circuitry 217 may be instantiated by the example microprocessor 900 of FIG. 9 executing machine executable instructions such as those implemented by at least block 602 of FIG. 6. In some examples, the navigation circuitry 217 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the navigation circuitry 217 may be instantiated by any other combination of hardware, software, and/or firmware. For example, the navigation circuitry 217 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example observer circuitry 206 enables monitoring of the status of a conversation/call, determination of whether objectives are being or will be achieved, etc. In some examples, the observer circuitry 206 monitors the conversation carried out between the return coordinator server 102 and the retailer 106. In examples disclosed herein, the conversation is monitored to identify a status of the conversation which may include, for example, a determination of whether the intent of the call has already been provided to the agent 110a, a determination of whether the intent is likely to be achieved, a determination of whether the conversation should be terminated, etc. To do so, the example observer circuitry 206 may prepare a prompt for execution by the LLM circuitry 222 and subsequently review and/or parse a response from the LLM to determine one or more statuses of the conversation. In some examples, the observer circuitry 206 determines whether the conversation (with the agent 110a) is aligned with the intent of the call (e.g., to place a return). In some examples, the example observer circuitry 206 can determine a re-focusing likelihood that indicates how likely it is that the conversation can be refocused on the intent (e.g., if the conversation has veered away from the intended topic). Further, the observer circuitry 206 can determine whether the re-focusing likelihood satisfies an example re-focusing threshold. In some examples, the observer circuitry 206 determines whether the agent 110a has requested information from the consumer 104 (e.g., purchase date of the item 108). For example, the observer circuitry 206 determines that the agent 110a has requested information from the consumer 104 based on agent speech.

The example observer circuitry 206 identifies example results, next steps, etc., associated with the call. The example observer circuitry 206 utilizes the LLM interface circuitry 208 to prompt the LLM circuitry 222 for selected phrases to be provided to the consumer 104 and/or the retailer 106. For example, the observer circuitry 206 determines the status of the return (e.g., complete, incomplete, in progress, etc.). In turn, the example observer circuitry 206 provides the status and/or any instructions (e.g., by prompting the LLM circuitry 222 via the LLM interface circuitry 208) to the consumer 104. For example, the observer circuitry 206 can generate a notification (e.g., text message, email, voicemail, paper mail, etc.) that provides the status and/or instructions to the consumer 104 (e.g., via consumer device). The example observer circuitry 206 determines whether the return is complete. For example, if the observer circuitry 206 determines that the return is not complete, then the observer circuitry 206 determines whether additional interaction is needed. In some examples, the observer circuitry 206 determines that additional interaction is needed, the phrase manager circuitry 212 can reinitiate the pre-call checks/procedures in preparation for another subsequent call with the same agent of the retailer 106 or a different agent of the retailer 106.

In some examples, the observer circuitry 206 is instantiated by programmable circuitry executing observation instructions and/or configured to perform operations such as those represented by the flowcharts of FIGS. 4 and 6. In some examples, the return coordinator server 102 includes means for observing. For example, the means for observing may be implemented by the observer circuitry 206. In some examples, the observer circuitry 206 may be instantiated by programmable circuitry such as the example programmable circuitry 812 of FIG. 8. For instance, the example observer circuitry 206 may be instantiated by the example microprocessor 900 of FIG. 9 executing machine executable instructions such as those implemented by at least blocks 410, 412, 414, 416 of FIG. 4 and blocks 618, 622, 626, 628, 634, 636 of FIG. 6. In some examples, the observer circuitry 206 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the observer circuitry 206 may be instantiated by any other combination of hardware, software, and/or firmware. For example, the observer circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example engager circuitry 218 of the illustrated example of FIG. 2 enables determinations/selections of phrases of what is to be said during the conversation/call with the agent 110a. The engager circuitry 218 utilizes the LLM interface circuitry 208 to prompt the LLM circuitry 222 for selected phrases to be provided to the agent 110a. For example, the engager circuitry 218 selects a phrase requesting repeat of agent speech (e.g., requesting the agent to repeat whatever they said). Additionally, the engager circuitry 218 can select a phrase (e.g., by prompting the LLM circuitry 222 via the LLM interface circuitry 208) that provides the intent of the call to the agent 110a. In some examples, the engager circuitry 218 can select a phrase (e.g., by prompting the LLM circuitry 222 via the LLM interface circuitry 208 or from the list of expected phrases) to re-focus the conversation, to end/terminate the call (e.g., when the intent of the call has been achieved), to provide information to the agent 110a (e.g., information requested by the agent 110a), etc.

In some examples, the engager circuitry 218 is instantiated by programmable circuitry executing engagement instructions and/or configured to perform operations such as those represented by the flowchart of FIG. 6. In some examples, the return coordinator server 102 includes means for engaging. For example, the means for engaging may be implemented by the example engager circuitry 218. In some examples, the engager circuitry 218 may be instantiated by programmable circuitry such as the example programmable circuitry 812 of FIG. 8. For instance, the example engager circuitry 218 may be instantiated by the example microprocessor 900 of FIG. 9 executing machine executable instructions such as those implemented by at least blocks 614, 620, 624, 630, 632, 638 of FIG. 6. In some examples, the engager circuitry 218 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the engager circuitry 218 may be instantiated by any other combination of hardware, software, and/or firmware. For example, the engager circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example LLM interface circuitry 208 interfaces with the LLM via the LLM circuitry 222 to provide a prompt that causes the LLM to generate a response. In some examples, the LLM interface circuitry 208 provides prompts at the request of the engager circuitry 218 and/or the observer circuitry 206. In some examples, multiple different LLMs may be utilized. In such examples, the LLM interface circuitry 208 may determine which LLM is to be utilized based on, for example, a type of a prompt to be provided to the LLM, whether the prompt was created by the engager circuitry 218 or the observer circuitry 206, etc.

In some examples, the LLM interface circuitry 208 is instantiated by programmable circuitry executing LLM interfacing instructions and/or configured to perform operations such as those represented by the flowcharts of FIGS. 4 and 6. In some examples, the return coordinator server 102 includes fourth means for interfacing. For example, the fourth means for interfacing may be implemented by the LLM interface circuitry 208. In some examples, the LLM interface circuitry 208 may be instantiated by programmable circuitry such as the example programmable circuitry 812 of FIG. 8. For instance, the example LLM interface circuitry 208 may be instantiated by the example microprocessor 900 of FIG. 9. In some examples, the LLM interface circuitry 208 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the LLM interface circuitry 208 may be instantiated by any other combination of hardware, software, and/or firmware. For example, the LLM interface circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example audio player circuitry 204 plays an example selected phrase (e.g., from the audio cache 210). For example, when the call handler circuitry 219 determines that the recognition confidence has failed a confidence threshold, then the audio player circuitry 204 plays audio corresponding to the selected phrase “Can you please repeat that?” to request a repeat of agent speech. In some examples, the audio player circuitry 204 plays example disfluent audio. For example, the audio player circuitry 204 may play disfluent audio to delay the conversation while the return coordinator server 102 determines a next action. For example, the audio player circuitry 204 can play disfluent audio while (e.g., simultaneously) the audio generator circuitry 214 generates audio for the selected phrase (e.g., because there is no corresponding audio in the audio cache 210). In some examples, disfluent audio may include filler words such as “Um,” “Ah,” etc., and/or phrases such as “One second, I need to think about that,” “Hold on,” “I think I know what you're saying,” etc.

In some examples, the audio player circuitry 204 is instantiated by programmable circuitry executing audio playing instructions and/or configured to perform operations such as those represented by the flowchart(s) of FIGS. 6 and 7. In some examples, the return coordinator server 102 includes means for executing audio. For example, the means for executing audio may be implemented by the audio player circuitry 204. In some examples, the audio player circuitry 204 may be instantiated by programmable circuitry such as the example programmable circuitry 812 of FIG. 8. For instance, the example audio player circuitry 204 may be instantiated by the example microprocessor 900 of FIG. 9 executing machine executable instructions such as those implemented by at least blocks 616, 639 of FIG. 6 and blocks 704, 706, 718 of FIG. 7. In some examples, the audio player circuitry 204 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the audio player circuitry 204 may be instantiated by any other combination of hardware, software, and/or firmware. For example, the audio player circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example cache interface circuitry 220 determines whether there is corresponding audio in the audio cache 210 associated with the selected phrase. In some examples, the example cache interface circuitry 220 determines whether the selected phrase (having no corresponding audio in the audio cache 210) can be divided (e.g., broken down) into sub-components.

Alternatively, if the cache interface circuitry 220 determines that the selected phrase can be divided into sub-components, then the cache interface circuitry 220 divides the selected phrase into sub-components. In turn, the example cache interface circuitry 220 determines whether the sub-components exist in the audio cache. If, for example, the cache interface circuitry 220 determines that the sub-components exist in the audio cache 210, then the cache interface circuitry 220 constructs the audio for the selected phrase based on the audio (e.g., distinct audio files) associated with the sub-components. Alternatively, if the example cache interface circuitry 220 determines that the sub-components do not exist in the audio cache 210, then the cache interface circuitry 220 generates the audio for the selected phrase (e.g., via the LLM circuitry 222). Additionally, the example cache interface circuitry 220 stores the audio in association with the selected phrase. Further, the cache interface circuitry 220 stores an indication of the phrase usage (e.g., a timestamp that the audio associated with the selected phrase was played).

In some examples, the cache interface circuitry 220 is instantiated by programmable circuitry executing cache interfacing instructions and/or configured to perform operations such as those represented by the flowchart of FIG. 7. In some examples, the return coordinator server 102 includes third means for interfacing. For example, the third means for interfacing may be implemented by the example cache interface circuitry 220. In some examples, the cache interface circuitry 220 may be instantiated by programmable circuitry such as the example programmable circuitry 812 of FIG. 8. For instance, the example cache interface circuitry 220 may be instantiated by the example microprocessor 900 of FIG. 9 executing machine executable instructions such as those implemented by at least blocks 700, 702, 708, 712, 714, 716, 720, 722 of FIG. 7. In some examples, the cache interface circuitry 220 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the cache interface circuitry 220 may be instantiated by any other combination of hardware, software, and/or firmware. For example, the cache interface circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

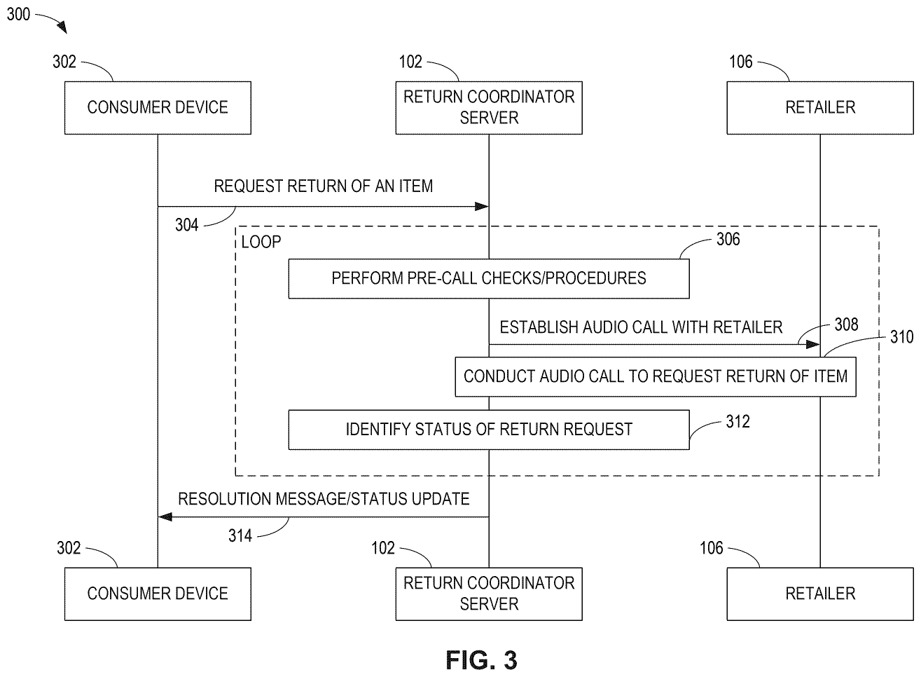

FIG. 3 is an example process flow diagram 300 showing an example implementation of the return coordinator server 102. The example process flow diagram 300 shows how an example consumer device 302 associated with the consumer 104 (FIG. 1) communicates with the return coordinator server 102 and, in turn, the retailer 106. At a first example communication 304, the return coordinator server 102 (via the consumer interface circuitry 200) detects a request from the consumer device 302 to return the item 108. Upon receipt of the first communication 304, the example return coordinator server 102 is prompted to perform pre-call checks/procedures via the phrase manager circuitry 212 (block 306). For example, the phrase manager circuitry 212 can determine a list of expected phrases to play during an example call with the retailer 106.

At a second communication 308, the return coordinator server 102 (via the call handler circuitry 219) establishes an audio call with the retailer 106. Upon receipt of the second communication 308 (e.g., when the agent 110a of the retailer 106 answers the call), the return coordinator server 102 executes the call with the retailer 106 via the call handler circuitry 219 (block 310). Further, the example return coordinator server 102 identifies the status of the return request via the observer circuitry 206 (block 312). In some examples, the return coordinator server 102 can repeat (e.g., loop) block 306, the second communication 308, block 310, and/or block 312 until the return coordination is complete. In some examples, multiple attempts to interact with an agent of the retailer 106 might be needed to successfully achieve the desired return coordination result. At a third example communication 314, the return coordinator server 102 transmits a resolution message (e.g., indicating a complete return) or a status update to the consumer device 302.

While an example manner of implementing the return coordinator server 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example consumer interface circuitry 200, the example phrase manager circuitry 212, the example audio generator circuitry 214, the example retailer interface circuitry 216, the example audio player circuitry 204, the example navigation circuitry 217, the example engager circuitry 218, the example call handler circuitry 219, the example cache interface circuitry 220, the example speech to text circuitry 221, the example LLM interface circuitry 208, the example observer circuitry 206, and/or, more generally, the example return coordinator server 102 of FIG. 2, may be implemented by hardware alone or by hardware in combination with software and/or firmware. Thus, for example, any of the example consumer interface circuitry 200, the example phrase manager circuitry 212, the example audio generator circuitry 214, the example retailer interface circuitry 216, the example audio player circuitry 204, the example navigation circuitry 217, the example engager circuitry 218, the example call handler circuitry 219, the example cache interface circuitry 220, the example speech to text circuitry 221, the example LLM interface circuitry 208, the example observer circuitry 206, and/or, more generally, the example return coordinator server 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example return coordinator server 102 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the return coordinator server 102 of FIG. 2 and/or representative of example operations which may be performed by programmable circuitry to implement and/or instantiate the return coordinator server 102 of FIG. 2, are shown in FIGS. 4-7. The machine readable instructions may be one or more executable programs or portion(s) of one or more executable programs for execution by programmable circuitry such as the programmable circuitry 812 shown in the example programmable circuitry platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-7, many other methods of implementing the example return coordinator server 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 300 that may be executed, instantiated, and/or performed by programmable circuitry to facilitate a return between the consumer 104 and the retailer 106. The example machine-readable instructions and/or the example operations 400 of FIG. 4 begin at block 402, at which the example consumer interface circuitry 200 accesses instructions to coordinate a return on behalf of the consumer 104. For example, the consumer interface circuitry 200 may be communicatively coupled to the consumer device 302 associated with the consumer 104 to access the instructions.

At block 404, the example consumer interface circuitry 200 identifies details of the return. For example, the consumer interface circuitry 200 identifies the item 108, the consumer 104, any information associated with the item 108 (e.g., type, price, color, barcode number, etc.), any information associated with the consumer 104 (e.g., address, payment information, username, etc.).

At block 406, the example phrase manager circuitry 212 performs pre-call checks/procedures, as described in detail below in connection with FIG. 5.

At block 408, the example call handler circuitry 219 conducts an example audio call with the retailer 106, as described in detail below in connection with FIG. 6.

At block 410, the example observer circuitry 206 identifies example results, next steps, etc., associated with the call.

At block 412, the example observer circuitry 206 determines the status of the return (e.g., complete, incomplete, in progress, etc.). Such determination may be made by, for example, interacting with the retailer 106 to determine whether they have received the item, interacting with a third-party platform (e.g., a banking and/or other financial system) to confirm that the consumer 104 has received a refund, etc.

At block 414, the example observer circuitry 206 provides the status and/or any instructions to the consumer 104. For example, the observer circuitry 206 generates a notification (e.g., by prompting the LLM circuitry 222 via the LLM interface circuitry 208) that provides the status and/or instructions to the consumer 104 (e.g., via the consumer device 302).

At block 416, the example observer circuitry 206 determines whether the return is complete. A return may be considered complete when, for example, the return has been coordinated, the product has been provided to the retailer 106, and the retailer 106 has issued a credit to the consumer 104. Of course, many other logical scenarios may be used to determine whether a return is complete (e.g., has a credit been issued after the consumer 104 was instructed to discard of the item 108 instead of sending the item 108 to the retailer 106, etc.). If the observer circuitry 206 determines that the return is not complete (block 416), then control of the process proceeds to block 418. Alternatively, if the example observer circuitry 206 determines that the return is complete (block 416), then the process ends.

At block 418, the example consumer interface circuitry 200 determines whether additional interaction is needed. If the example consumer interface circuitry 200 determines that additional interaction is needed, then control of the process returns to block 406. For example, the phrase manager circuitry 212 can reinitiate the pre-call checks/procedures in preparation for another subsequent call with the same agent of the retailer 106 or a different agent of the retailer 106. Alternatively, if the example consumer interface circuitry 200 determines that additional interaction is not needed then control of the process returns to block 412. The example process of blocks 412 through 418 may then be repeated until it is determined that either the return has been completed, or additional interaction is needed.

FIG. 5 is a flowchart representative of example machine readable instructions and/or example operations that may be executed, instantiated, and/or performed by programmable circuitry to perform pre-call checks/procedures in connection with block 406 of FIG. 4. The example machine-readable instructions and/or the example operations of FIG. 5 begin at block 500, at which the example retailer interface circuitry 216 identifies the retailer 106 that will be involved in the audio call.

At block 502, the example retailer interface circuitry 216 identifies call details (e.g., an address, a store number, a type of agent (e.g., the agents 110a-110c), an industry) based on the retailer 106.

At block 504, the example phrase manager circuitry 212 accesses the list of common phrases (e.g., “I need to return my item,” “My order number is AB1234,” etc.).

At block 506, the example phrase manager circuitry 212 generates a list of anticipated phrases (e.g., based on the item 108, the retailer 106, the consumer 104, etc.).

At block 508, the example phrase manager circuitry 212 merges the list of common phrases and the list of anticipated phrases to form an example list of expected phrases.

At block 510, the example phrase manager circuitry 212 identifies a phrase in the list of expected phrases.

At block 512, the example phrase manager circuitry 212 determines whether there is corresponding audio in the audio cache 210 for the identified phrase. For example, if the phrase manager circuitry 212 determines that the audio cache 210 does not have corresponding audio for the identified phrase, then control of the process proceeds to block 514. Alternatively, if the example phrase manager circuitry 212 determines that the audio cache 210 includes corresponding audio for the identified phrase, then control of the process proceeds to block 518.

At block 514, the example audio generator circuitry 214 generates audio corresponding to the identified phrase.

At block 516, the example audio generator circuitry 214 stores the generated audio in the audio cache 210 in association with the identified phrase.

At block 518, the example phrase manager circuitry 212 determines whether there are additional phrases to evaluate. For example, if the phrase manager circuitry 212 determines that there are additional phrases to evaluate, then control of the process returns to block 510. Alternatively, if the example phrase manager circuitry 212 determines that there are no additional phrases to evaluate, then control of the process returns to FIG. 4.

FIG. 6 is a flowchart representative of example machine readable instructions and/or example operations that may be executed, instantiated, and/or performed by programmable circuitry to conduct an audio call with the retailer 106 in connection with block 408 of FIG. 4. The example machine-readable instructions and/or the example operations of FIG. 6 begin at block 600, at which the example call handler circuitry 219 places (e.g., initiates, dials, etc.) the call to the retailer 106.

At block 602, the example navigation circuitry 217 navigates through prompts (e.g., “Press 2 to speak with an agent”) to speak with one of the agents 110a-110c.

At block 604, the example call handler circuitry 219 collects audio from one of the agents 110a-110c.

At block 608, the example call handler circuitry 219 determines whether the agent audio is sufficient. For example, if the call handler circuitry 219 determines that the agent audio is sufficient (e.g., loud enough, clear enough, etc.), then control of the process proceeds to block 610. Alternatively, if the example call handler circuitry 219 determines that the agent audio is not sufficient, then control of the process returns to 604.

At block 610, the example speech to text circuitry 221 recognizes (e.g., converts) the agent audio as text when the agent audio is sufficient (e.g., sufficiently loud, sufficiently clear, etc.).

At block 612, the example call handler circuitry 219 determines whether the recognition confidence associated with the agent audio meets a confidence threshold. In some examples, the call handler circuitry 219 monitors the agent speech for a time period (e.g., 5 seconds, 10 seconds, etc.) to determine whether the recognition confidence meets a confidence threshold. If the example call handler circuitry 219 determines that the recognition confidence associated with the agent audio does not meet (e.g., fails) a confidence threshold, then control of the process proceeds to block 614. Alternatively, if the example call handler circuitry 219 determines that the recognition confidence associated with the agent audio meets (e.g., satisfies, is greater than, etc.) the confidence threshold, then control of the process proceeds to block 618.

At block 614, the example engager circuitry 218 selects a phrase (e.g., (e.g., by prompting the LLM circuitry 222 via the LLM interface circuitry 208) requesting repeat of agent speech. For example, the engager circuitry 218 selects the phrase “Can you please repeat that?” to request a repeat of agent speech.

At block 616, the example audio player circuitry 204 plays the corresponding audio associated with the selected phrase, as described in detail in connection with FIG. 7. In some examples, when the engager circuitry 218 determines that the recognition confidence has failed a confidence threshold, then the audio player circuitry 204 plays the selected phrase “Can you please repeat that?” to request a repeat of agent speech.

At block 618, the example observer circuitry 206 determines whether the intent of the call has been provided to the agent 110a. For example, if the observer circuitry 206 determines that the intent of the call has not yet been provided to the agent 110a (e.g., by analyzing the call history), then control of the process proceeds to block 620. Alternatively, if the example observer circuitry 206 determines that the intent of the call has already been provided to the agent (e.g., by analyzing the call history), then control of the process proceeds to block 622.

At block 620, the example engager circuitry 218 selects a phrase (e.g., by prompting the LLM circuitry 222 via the LLM interface circuitry 208) that provides the intent of the call to the agent 110a. In turn, the audio player circuitry 204 (at block 616) plays the audio associated with the selected phrase (e.g., “I'd like to return an item.”).

At block 622, the example observer circuitry 206 determines whether the agent 110a has asked for additional information. For example, if the observer circuitry 206 determines that the agent 110a has asked for additional information (e.g., by asking a question), then control of the process proceeds to block 624. Alternatively, if the example observer circuitry 206 determines that the agent 110a has not asked for additional information, then control of the process proceeds to block 626.

At block 624, the example engager circuitry 218 selects a phrase (e.g., by prompting the LLM circuitry 222 via the LLM interface circuitry 208) to provide the requested information to the agent 110a. For example, if the observer circuitry 206 determines that the agent 110a has requested purchase date of the item 108, then the engager circuitry 218 selects a phrase that provides the purchase date of the item 108. In turn, the audio player circuitry 204 (at block 616) plays the audio associated with the selected phrase (e.g., “I purchased this item on Jan. 1, 2024.”).

At block 626, the example observer circuitry 206 determines whether the intent of the call has been achieved. For example, if the observer circuitry 206 determines that the intent of the call has not been achieved (e.g., the return is incomplete), then control of the process proceeds to block 628. Alternatively, if the example observer circuitry 206 determines that the intent of the call has been achieved (e.g., the return is complete), then control of the process proceeds to block 630.

At block 628, the example observer circuitry 206 determines whether the conversation (with the agent 110a) is aligned with the intent of the call (e.g., to place a return). For example, if the observer circuitry 206 determines that the conversation is aligned with the intent of the call, then control of the process proceeds to block 632. Alternatively, if the example observer circuitry 206 determines that the conversation is misaligned with the intent of the call, then control of the process proceeds to block 634.

At block 632, the example engager circuitry 218 analyzes the call history to select a phrase (e.g., by prompting the LLM circuitry 222 via the LLM interface circuitry 208) to continue the conversation to be aligned with the intent. In turn, the example audio player circuitry 204 (at block 616) plays the audio associated with the selected phrase (e.g., “As I was saying, I need help determining where to send my item to return it.”).

At block 634, the example observer circuitry 206 determines a likelihood that the conversation can be re-focused (e.g., re-focused on the intent).

At block 636, the example observer circuitry 206 determines whether the likelihood meets a re-focusing threshold. For example, if the observer circuitry 206 determines that the likelihood meets the re-focusing threshold, then control of the process proceeds to block 638. Alternatively, if the example observer circuitry 206 determines that the likelihood does not meet to the re-focusing threshold, then control of the process proceeds to block 630.

At block 638, the example engager circuitry 218 selects a phrase (e.g., by prompting the LLM circuitry 222 via the LLM interface circuitry 208) to re-focus the conversation. In turn, the example audio player circuitry 204 (at block 616) plays the audio associated with the selected phrase (e.g., “I'm sorry, can you please help me with my return instead?”).

At block 630, the example engager circuitry 218 selects a phrase (e.g., by prompting the LLM circuitry 222 via the LLM interface circuitry 208) to end the call. In some examples, the engager circuitry 218 can select a phrase to end/terminate the call when the intent of the call has been achieved (block 626).

At block 639, the example audio player circuitry 204 plays the audio associated with the selected phrase (e.g., “I have to go now,” “Goodbye,” etc.).

At block 640, the example call handler circuitry 219 terminates the call. Then, the process returns to FIG. 4.

FIG. 7 is a flowchart representative of example machine readable instructions and/or example operations that may be executed, instantiated, and/or performed by programmable circuitry to play a selected phrase in connection with block 616 of FIG. 6. The example machine-readable instructions and/or the example operations of FIG. 7 begin at block 700, at which the example cache interface circuitry 220 identifies the selected phrase in the list of expected phrases (e.g., based on a selection by the engager circuitry 218).

At block 702, the example cache interface circuitry 220 determines whether there is corresponding audio in the audio cache 210 associated with the selected phrase. For example, if the cache interface circuitry 220 determines that there is corresponding audio associated with the selected phrase, then control of the process proceeds to block 704. Alternatively, if the example cache interface circuitry 220 determines that there is no corresponding audio associated with the selected phrase, then control of the process proceeds to block 706.

At block 704, the example audio player circuitry 204 plays the corresponding audio for the selected phrase.

At block 706, the example audio player circuitry 204 plays example disfluent audio. In such examples, the audio player circuitry 204 plays disfluent audio to delay and/or stall the conversation. In some examples, disfluent audio may include filler words such as “Um,” “Ah,” etc., and/or phrases such as “One second, I need to think about that,” “Hold on,” “I think I know what you're saying,” etc.

At block 708, the example cache interface circuitry 220 determines whether the selected phrase (having no corresponding audio in the audio cache 210) can be divided (e.g., broken down) into sub-components. Such division may be based on, for example, separate words being used to compose the entirety of the phrase. For example, if the cache interface circuitry 220 determines that the selected phrase cannot be divided into sub-components, then control of the process proceeds to block 710. Alternatively, if the example cache interface circuitry 220 determines that the selected phrase can be divided into sub-components, then control of the process proceeds to block 712.

At block 710, the example audio generator circuitry 214 generates audio for the selected phrase.

At block 712, the example cache interface circuitry 220 divides the selected phrase into sub-components.

At block 714, the example cache interface circuitry 220 determines whether the sub-components exist in the audio cache 210. For example, if the cache interface circuitry 220 determines that the sub-components exist in the audio cache 210, then control of the process proceeds to block 716. Alternatively, if the example cache interface circuitry 220 determines that the sub-components do not exist in the audio cache 210, then control of the process returns to block 710.

At block 716, the example cache interface circuitry 220 generates the audio for the selected phrase based on the audio (e.g., distinct audio files) associated with the sub-components. For example, the cache interface circuitry 220 can splice together the audio files for the sub-components to generate the audio for the selected phrase.

At block 718, the example audio player circuitry 204 plays the audio (e.g., generated by the LLM circuitry 222, spliced together based on sub-components in the audio cache 210, etc.) corresponding to the selected phrase.

At block 720, the example cache interface circuitry 220 stores the audio in association with the selected phrase.

At block 722, the example cache interface circuitry 220 stores an indication of the phrase usage (e.g., a timestamp that the audio associated with the selected phrase was played) in the audio cache 210. Then, the process returns to FIG. 6.

FIG. 8 is a block diagram of an example programmable circuitry platform 800 structured to execute and/or instantiate the example machine-readable instructions and/or the example operations of FIGS. 4-7 to implement the return coordinator server 102 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example consumer interface circuitry 200, the example phrase manager circuitry 212, the example audio generator circuitry 214, the example retailer interface circuitry 216, the example audio player circuitry 204, the example navigation circuitry 217, the example engager circuitry 218, the example call handler circuitry 219, the example cache interface circuitry 220, the example speech to text circuitry 221, the example LLM interface circuitry 208, the example observer circuitry 206. The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 4-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 4-7 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 4-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 4-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-7. As such, the FPGA circuitry 1000 may be configured and/or structured to effectively instantiate some or all of the operations/functions corresponding to the machine readable instructions of the flowchart(s) of FIGS. 4-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 4-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 4-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 4-7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIGS. 4-7, and/or an ASIC may be configured and/or structured to perform third operation(s)/function(s) corresponding to a third portion of the machine readable instructions represented by the flowcharts of FIGS. 4-7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

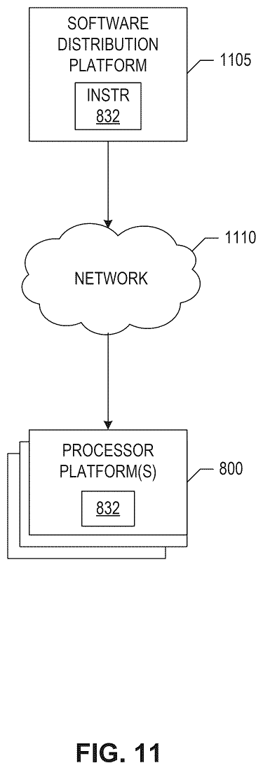

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 4-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 4-7, may be downloaded to the example programmable circuitry platform 800, which is to execute the machine readable instructions 832 to implement the return coordinator server 102. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable the return of products in a manner that reduces complexity for any person involved in the return of a product. Examples disclosed herein initiate and conduct audio calls with a representative (e.g., robotic representative, human representative, etc.) of a retailer to facilitate returns. For example, disclosed examples can access a consumer device associated with a consumer (e.g., a person seeking to return a product) to call and engage with such an example representative. Disclosed examples can provide return data (e.g., order number, order receipt, consumer identity information, etc.) to the example representative on behalf of a consumer. As such, disclosed examples minimize or eliminate direct consumer involvement with a retail representative. Disclosed systems, apparatus, articles of manufacture, and methods improve the efficiency of using a computing device by providing access to and/or continuously updating an example audio cache with common phrases, anticipated phrases, and/or expected phrases involved in the facilitation of a return between an example consumer and an example retailer. Disclosed systems, apparatus, articles of manufacture, and methods are accordingly directed to one or more improvement(s) in the operation of a machine such as a computer or other electronic and/or mechanical device.

Example 1 includes at least one non-transitory machine-readable medium comprising machine-readable instructions to cause at least one processor circuit to at least determine metadata associated with a return of at least one of an item or a service, generate phrases corresponding to the metadata, compare the generated phrases to stored phrases in an audio cache, the audio cache including stored audio files in association with the stored phrases, when a first stored phrase of the stored phrases matches a first generated phrase of the generated phrases, access a first stored audio file of the stored audio files, the first stored audio file associated with the matching first stored phrase, generate an audio file for a second generated phrase of the generated phrases, the second generated phrase different from the stored phrases, store the generated audio file in the audio cache in association with the second generated phrase, and execute an audio call with the stored phrases in the audio cache, the audio call directed to a retailer to attempt to coordinate the return.

Example 2 includes the at least one non-transitory machine-readable medium of example 1, wherein the machine-readable instructions are to cause one or more of the at least one processor circuit to monitor the audio call for retailer audio, the retailer audio generated by an agent associated with the retailer, the agent facilitating the audio call on behalf of the retailer, generate a response phrase associated with the retailer audio, the generated response phrase to be used to respond to the retailer audio, the generated response phrase including text, compare the text of the generated response phrase to text associated with the stored phrases in the audio cache, and when the text of the generated response phrase matches text of a second stored phrase in the audio cache, access a second stored audio file, the second stored audio file corresponding to the matching second stored phrase.

Example 3 includes the at least one non-transitory machine-readable medium of example 1 or example 2, wherein the retailer audio is a question asked by the agent.

Example 4 includes the at least one non-transitory machine-readable medium of any one of examples 1-3, wherein the matching second stored phrase is an answer to the question.

Example 5 includes the at least one non-transitory machine-readable medium of any one of examples 1-4, wherein the machine-readable instructions are to cause one or more of the at least one processor circuit to play the second stored audio file in the audio call.

Example 6 includes the at least one non-transitory machine-readable medium of any one of examples 1-5, wherein the at least one of the item or the service was purchased by a consumer, the metadata including information about the consumer.

Example 7 includes the at least one non-transitory machine-readable medium of any one of examples 1-6, wherein the machine-readable instructions are to cause one or more of the at least one processor circuit to determine metadata associated with the return after receipt of an instruction to coordinate the return.

Example 8 includes an apparatus comprising interface circuitry, machine-readable instructions, and at least one processor circuit to be programmed by the machine-readable instructions to determine metadata associated with a return of at least one of an item or a service, generate phrases corresponding to the metadata, compare the generated phrases to stored phrases in an audio cache, the audio cache including stored audio files in association with the stored phrases, when a first stored phrase of the stored phrases matches a first generated phrase of the generated phrases, access a first stored audio file of the stored audio files, the first stored audio file associated with the matching first stored phrase, generate an audio file for a second generated phrase of the generated phrases, the second generated phrase different from the stored phrases, store the generated audio file in the audio cache in association with the second generated phrase, and execute an audio call with the stored phrases in the audio cache, the audio call directed to a retailer to attempt to coordinate the return.

Example 9 includes the apparatus of example 8, wherein one or more of the at least one processor circuit is to monitor the audio call for retailer audio, the retailer audio generated by an agent associated with the retailer, the agent facilitating the audio call on behalf of the retailer, generate a response phrase associated with the retailer audio, the generated response phrase to be used to respond to the retailer audio, the generated response phrase include text, compare the text of the generated phrase to text associated with the stored phrases in the audio cache, and when the text of the generated response phrase matches text of a second stored phrase in the audio cache, access a second stored audio file, the second stored audio file corresponding to the matching second stored phrase.

Example 10 includes the apparatus of example 8 or example 9, wherein the retailer audio is a question asked by the agent.

Example 11 includes the apparatus of any one of examples 8-10, wherein the matching second stored phrase is an answer to the question.

Example 12 includes the apparatus of any one of examples 8-11, wherein one or more of the at least one processor circuit is to play the second stored audio file in the audio call.

Example 13 includes the apparatus of any one of examples 8-12, wherein the at least one of the item or the service was purchased by a consumer, the metadata including information about the consumer.

Example 14 includes the apparatus of any one of examples 8-13, wherein one or more of the at least one processor circuit is to determine metadata associated with the return after receipt of an instruction to coordinate the return.

Example 15 includes a method comprising determining, by at least one processor circuit programmed by at least one instruction, metadata associated with a return of at least one of an item or a service, generating, by one or more of the at least one processor circuit, phrases corresponding to the metadata, comparing, by one or more of the at least one processor circuit, the generated phrases to stored phrases in an audio cache, the audio cache including stored audio files in association with the stored phrases, when a first stored phrase of the stored phrases matches a first generated phrase of the generated phrases, accessing, by one or more of the at least one processor circuit, a first stored audio file of the stored audio files, the first stored audio file associated with the matching first stored phrase, generating, by one or more of the at least one processor circuit, an audio file for a second generated phrase of the generated phrases, the second generated phrase different from the stored phrases, storing, by one or more of the at least one processor circuit, the generated audio file in the audio cache in association with the second generated phrase, and executing, by one or more of the at least one processor circuit, an audio call with the stored phrases in the audio cache, the audio call directed to a retailer to attempt to coordinate the return.

Example 16 includes the method of example 15, further including monitoring the audio call for retailer audio, the retailer audio generated by an agent associated with the retailer, the agent facilitating the audio call on behalf of the retailer, generating a response phrase associated with the retailer audio, the generated response phrase to be used to respond to the retailer audio, the generated response phrase including text, comparing the text of the generated response phrase to text associated with the stored phrases in the audio cache, and when the text of the generated response phrase matches text of a second stored phrase in the audio cache, accessing a second stored audio file, the second stored audio file corresponding to the matching second stored phrase.

Example 17 includes the method of example 15 or example 16, wherein the retailer audio is a question asked by the agent.

Example 18 includes the method of any one of examples 15-17, further including playing the second stored audio file in the audio call.

Example 19 includes the method of any one of examples 15-18, further including playing the second stored audio file in the audio call.

Example 20 includes the method of any one of examples 15-19, wherein the at least one of the item or the service was purchased by a consumer, the metadata including information about the consumer.

Example 21 includes the method of any one of examples 15-20, further including determining metadata associated with the return after receipt of an instruction to coordinate the return.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory machine-readable medium comprising machine-readable instructions to cause at least one processor circuit to at least:
determine metadata associated with a return of at least one of an item or a service;
generate phrases corresponding to the metadata;
compare the generated phrases to stored phrases in an audio cache, the audio cache including stored audio files in association with the stored phrases;
when a first stored phrase of the stored phrases matches a first generated phrase of the generated phrases, access a first stored audio file of the stored audio files, the first stored audio file associated with the matching first stored phrase;
generate an audio file for a second generated phrase of the generated phrases, the second generated phrase different from the stored phrases;
store the generated audio file in the audio cache in association with the second generated phrase; and
execute an audio call with the stored phrases in the audio cache, the audio call directed to a retailer to attempt to coordinate the return.

2. The at least one non-transitory machine-readable medium of claim 1, wherein the machine-readable instructions are to cause one or more of the at least one processor circuit to:
monitor the audio call for retailer audio, the retailer audio generated by an agent associated with the retailer, the agent facilitating the audio call on behalf of the retailer;
generate a response phrase associated with the retailer audio, the generated response phrase to be used to respond to the retailer audio, the generated response phrase including text;
compare the text of the generated response phrase to text associated with the stored phrases in the audio cache; and
when the text of the generated response phrase matches text of a second stored phrase in the audio cache, access a second stored audio file, the second stored audio file corresponding to the matching second stored phrase.

3. The at least one non-transitory machine-readable medium of claim 2, wherein the retailer audio is a question asked by the agent.

4. The at least one non-transitory machine-readable medium of claim 3, wherein the matching second stored phrase is an answer to the question.

5. The at least one non-transitory machine-readable medium of claim 2, wherein the machine-readable instructions are to cause one or more of the at least one processor circuit to play the second stored audio file in the audio call.

6. The at least one non-transitory machine-readable medium of claim 1, wherein the at least one of the item or the service was purchased by a consumer, the metadata including information about the consumer.

7. The at least one non-transitory machine-readable medium of claim 1, wherein the machine-readable instructions are to cause one or more of the at least one processor circuit to determine metadata associated with the return after receipt of an instruction to coordinate the return.

8. An apparatus comprising:
interface circuitry;
machine-readable instructions; and
at least one processor circuit to be programmed by the machine-readable instructions to:
determine metadata associated with a return of at least one of an item or a service;
generate phrases corresponding to the metadata;
compare the generated phrases to stored phrases in an audio cache, the audio cache including stored audio files in association with the stored phrases;
when a first stored phrase of the stored phrases matches a first generated phrase of the generated phrases, access a first stored audio file of the stored audio files, the first stored audio file associated with the matching first stored phrase;
generate an audio file for a second generated phrase of the generated phrases, the second generated phrase different from the stored phrases;
store the generated audio file in the audio cache in association with the second generated phrase; and
execute an audio call with the stored phrases in the audio cache, the audio call directed to a retailer to attempt to coordinate the return.

9. The apparatus of claim 8, wherein one or more of the at least one processor circuit is to:
monitor the audio call for retailer audio, the retailer audio generated by an agent associated with the retailer, the agent facilitating the audio call on behalf of the retailer;
generate a response phrase associated with the retailer audio, the generated response phrase to be used to respond to the retailer audio, the generated response phrase include text;
compare the text of the generated phrase to text associated with the stored phrases in the audio cache; and
when the text of the generated response phrase matches text of a second stored phrase in the audio cache, access a second stored audio file, the second stored audio file corresponding to the matching second stored phrase.

10. The apparatus of claim 9, wherein the retailer audio is a question asked by the agent.

11. The apparatus of claim 10, wherein the matching second stored phrase is an answer to the question.

12. The apparatus of claim 9, wherein one or more of the at least one processor circuit is to play the second stored audio file in the audio call.

13. The apparatus of claim 8, wherein the at least one of the item or the service was purchased by a consumer, the metadata including information about the consumer.

14. The apparatus of claim 8, wherein one or more of the at least one processor circuit is to determine metadata associated with the return after receipt of an instruction to coordinate the return.

15. A method comprising:
determining, by at least one processor circuit programmed by at least one instruction, metadata associated with a return of at least one of an item or a service;
generating, by one or more of the at least one processor circuit, phrases corresponding to the metadata;
comparing, by one or more of the at least one processor circuit, the generated phrases to stored phrases in an audio cache, the audio cache including stored audio files in association with the stored phrases;
when a first stored phrase of the stored phrases matches a first generated phrase of the generated phrases, accessing, by one or more of the at least one processor circuit, a first stored audio file of the stored audio files, the first stored audio file associated with the matching first stored phrase;
generating, by one or more of the at least one processor circuit, an audio file for a second generated phrase of the generated phrases, the second generated phrase different from the stored phrases;
storing, by one or more of the at least one processor circuit, the generated audio file in the audio cache in association with the second generated phrase; and
executing, by one or more of the at least one processor circuit, an audio call with the stored phrases in the audio cache, the audio call directed to a retailer to attempt to coordinate the return.

16. The method of claim 15, further including:
monitoring the audio call for retailer audio, the retailer audio generated by an agent associated with the retailer, the agent facilitating the audio call on behalf of the retailer;
generating a response phrase associated with the retailer audio, the generated response phrase to be used to respond to the retailer audio, the generated response phrase including text;
comparing the text of the generated response phrase to text associated with the stored phrases in the audio cache; and
when the text of the generated response phrase matches text of a second stored phrase in the audio cache, accessing a second stored audio file, the second stored audio file corresponding to the matching second stored phrase.

17. The method of claim 16, wherein the retailer audio is a question asked by the agent.

18. The method of claim 16, further including playing the second stored audio file in the audio call.

19. The method of claim 15, wherein the at least one of the item or the service was purchased by a consumer, the metadata including information about the consumer.

20. The method of claim 15, further including determining metadata associated with the return after receipt of an instruction to coordinate the return.
